(19) United States
(12) Patent Application Publication
(10) Pub. No.: US 2016/0071318 A1
(43) Pub. Date: Mar. 10, 2016

(54) Real-Time Dynamic Three-Dimensional Adaptive Object Recognition and Model Reconstruction

(71) Applicant: VanGogh Imaging, Inc., McLean, VA (US)

(72) Inventors: Ken Lee, Fairfax, VA (US); Jun Yin, McLean, VA (US)

(21) Appl. No.: 14/849,172

(22) Filed: Sep. 9, 2015

Related U.S. Application Data
(60) Provisional application No. 62/048,560, filed on Sep. 10, 2014.
(60) Provisional application No. 62/129,336, filed on Mar. 6, 2015.

(51) Int. Cl. G06T 17/20; G06K 9/46; G06K 9/00; G06T 7/00

(52) U.S. Cl. CPC G06T 17/20; G06T 7/0046; G06T 7/0071; G06T 7/0085; G06K 9/4609; G06K 9/00214; G06T 2207/10028

(57) ABSTRACT

Methods and systems are described for generating a three-dimensional (3D) model of an object represented in a scene. A computing device receives a plurality of images captured by a sensor, each image depicting a scene containing physical objects and at least one object moving and/or rotating. The computing device generates a scan of each image comprising a point cloud corresponding to the scene and objects. The computing device removes one or more flat surfaces from each point cloud and crops one or more outlier points from the point cloud after the flat surfaces are removed using a determined boundary of the object to generate a filtered point cloud of the object. The computing device generates an updated 3D model of the object based upon the filtered point cloud and an in-process 3D model, and updates the determined boundary of the object based upon the filtered point cloud.

### RELATED APPLICATIONS

This application claims priority to U.S. Provisional Patent Application No. 62/048,560, filed on Sep. 10, 2014, and U.S. Provisional Patent Application No. 62/129,336, filed on Mar. 6, 2015; the contents of each of which are incorporated herein in their entirety.

### TECHNICAL FIELD

The subject matter of this application relates generally to methods and apparatuses, including computer program products, for real-time dynamic three-dimensional (3D) adaptive object recognition and model reconstruction, using a dynamic reference model and in cases involving occlusion or moving objects—including 3D scanning by hand.

### BACKGROUND

Low-cost 3D sensors are becoming more affordable for use in various software applications, such as Project Tango mobile devices with built-in 3D sensors available from Google, Inc. of Mountain View, Calif., and the RealSense™ 3D sensor for tablets available from Intel Corp. of Santa Clara, Calif.

However, existing techniques for 3D model reconstruction using such sensors typically requires a turntable to rotate the object being scanned and/or computer-aided design (CAD) tools to manually align object scans taken from different camera perspectives so that the object scans can be merged properly into a 3D model.

One difficulty in 3D modeling is that the object being scanned is not fully visible at any particular position (such as the bottom of the object) and requires the operator to manually rotate the object to provide a direct view of the occluded parts of the object. Once the operator manually moves and rotates the object, however, the scanning software typically loses the pose (i.e., position and orientation) of the object. Further, in a real-world scene, the object being scanned may be moving relative to the camera or sensor. Once the pose information is lost from one scan to the next, additional scans are no longer in the same 3D coordinate systems as the previous scans. Therefore, to register all the scans, the operator needs to align the scans manually using a CAD tool. Such processes make it difficult for a user to easily create 3D models because these processes are not only complex but also generally take tens of minutes to hours to complete, depending on the object size and shape.

Another difficulty in 3D modeling is that the hands cannot be visible to the camera during the scanning process. Therefore, the scanning process needs to stop while the hand is used to rotate the object. This approach makes the process more time-consuming and less user-friendly. Additionally, if captured by the sensor, a hand holding the object (or other similar ‘noises’ around the object) must be cropped or deleted from the scene.

Further, there is a great deal of interest in using 3D sensors to recognize objects in 3D space based upon their shapes—in order to enhance existing application features, functionality, and user experiences or to create new applications. Unfortunately, in the real-world, objects are generally of significantly different size and shape than a reference model. For example, trying to locate a dog in a scene can be difficult because dogs come in many different shapes and sizes. Therefore, a ‘standard’ dog reference model may not be able to locate the dog correctly in the scene, if at all. One way to solve this problem is to create a large database of ‘dog models’ of different breeds and sizes and compare them one at a time against the object in the scene. However, this approach is too time consuming and not practical as well as not being able to run in real-time using conventional mobile and embedded processing. Therefore, this adaptive object recognition is used to simplify the 3D modeling process as well as to for other applications.

### SUMMARY

Therefore, what is needed is a solution for 3D model reconstruction that is robust, efficient, and real-time and yet also very flexible such that the object can be moving and manipulated by hand during the reconstruction process. The present application describes systems and methods for real-time dynamic three-dimensional (3D) model reconstruction of an object, where the object scans include occlusions (e.g. a user's hand in the scan) and/or moving objects within the scan. The techniques described herein provide the advantage of allowing a user to rotate the object being scanned by any means—including by hand—while dynamically reconstructing the 3D model. The ‘common points’ of the object (e.g. those object points that are common across multiple scans of the object, in some cases, at different angles) are kept while points that are changing inside the scene (e.g. a user's hand) are selectively deleted from the scans.

The techniques described herein incorporates the following elements:
Dynamic Simultaneous Localization and Mapping (D-SLAM)—Providing local tracking of the object in the scene and merging objects located in multiple scans, while also removing noise;
Object Boundary Identification—Identifying the boundary of the object in the scene to remove outliers; and
Adaptive Object Recognition—Providing global tracking with a dynamically-created 3D reference model.

The methods and systems described herein dynamically generate an object boundary in real-time. The object boundary consists of many small voxels with a size of X*Y*Z. Every point in the source scan falls into a voxel. If the voxel is set to be valid, any points located in this voxel are considered as valid. As a result, outlier points are removed from the source scan points since they are outside of valid voxels. Specifically, the object boundary is dynamically updated with every single source scan, as will be described in greater detail below.

The systems and methods described in this application utilize the object recognition and modeling techniques described in U.S. patent application Ser. No. 14/324,891, titled “Real-Time 3D Computer Vision Processing Engine for Object Recognition, Reconstruction, and Analysis,” which is incorporated herein by reference. Such methods and systems are available by implementing the Starry Night plug-in for the Unity 3D development platform, available from VanGogh Imaging, Inc. of McLean, Va.

For adaptive object recognition, what is needed are methods and systems for efficiently recognizing and extracting objects from a scene that may be quite different in size and shape from the original reference model. Such systems and methods can be created using the object recognition and modeling techniques described in U.S. patent application Ser. No. 14/324,891, incorporated herein by reference, and adding to those techniques a feedback loop to dynamically adjust the size and shape of the reference model being used.

The techniques described herein are useful in applications such as 3D printing, parts inspection, medical imaging, robotics control, augmented reality, automotive safety, security, and other such applications that require real-time classification, location, orientation, and analysis of the object in the scene by being able to correctly extract the object from the scene and create a full 3D model from it. Such methods and systems are available by implementing the Starry Night plug-in for the Unity 3D development platform, available from VanGogh Imaging, Inc. of McLean, Va.

The invention, in one aspect, features a computerized method for generating a three-dimensional (3D) model of an object represented in a scene. An image processing module of a computing device receives a plurality of images captured by a sensor coupled to the computing device, each image depicting a scene containing one or more physical objects, where at least one of the objects moves and/or rotates between capture of different images. The image processing module generates a scan of each image comprising a 3D point cloud corresponding to the scene and objects. The image processing module removes one or more flat surfaces from each 3D point cloud and crops one or more outlier points from the 3D point cloud after the flat surfaces are removed using a determined boundary of the object to generate a filtered 3D point cloud of the object. The image processing module generates an updated 3D model of the object based upon the filtered 3D point cloud and an in-process 3D model, and updates the determined boundary of the object based upon the filtered 3D point cloud.

The invention, in another aspect, features a system for generating a three-dimensional (3D) model of an object represented in a scene. The system includes a sensor coupled to a computing device and an image processing module executing on the computing device. The image processing module is configured to receive a plurality of images captured by the sensor, each image depicting a scene containing one or more physical objects, where at least one of the objects moves and/or rotates between capture of different images. The image processing module is configured to generate a scan of each image comprising a 3D point cloud corresponding to the scene and objects. The image processing module is configured to remove one or more flat surfaces from each 3D point cloud and crop one or more outlier points from the 3D point cloud after the flat surfaces are removed using a determined boundary of the object to generate a filtered 3D point cloud of the object. The image processing module is configured to generate an updated 3D model of the object based upon the filtered 3D point cloud and an in-process 3D model, and update the determined boundary of the object based upon the filtered 3D point cloud.

The invention, in another aspect, features a computer program product, tangibly embodied in a non-transitory computer readable storage device, for generating a three-dimensional (3D) model of an object represented in a scene. The computer program product includes instructions operable to cause an image processing module executing on a processor of a computing device to receive a plurality of images captured by a sensor coupled to the computing device, each image depicting a scene containing one or more physical objects, wherein at least one of the objects moves and/or rotates between capture of different images. The computer program product includes instructions operable to cause the image processing module to generate a scan of each image comprising a 3D point cloud corresponding to the scene and objects. The computer program product includes instructions operable to cause the image processing module to remove one or more flat surfaces from each 3D point cloud and crop one or more outlier points from the 3D point cloud after the flat surfaces are removed using a determined boundary of the object to generate a filtered 3D point cloud of the object. The computer program product includes instructions operable to cause the image processing module to generate an updated 3D model of the object based upon the filtered 3D point cloud and an in-process 3D model, and update the determined boundary of the object based upon the filtered 3D point cloud.

Any of the above aspects can include one or more of the following features. In some embodiments, generating an updated 3D model of the object comprises transforming each point in the filtered 3D point cloud by a rotation matrix and translation vector corresponding to each point in the initial 3D model, determining whether the transformed point is farther away from a surface region of the in-process 3D model, merging the transformed point into the in-process 3D model to generate an updated 3D model if the transformed point is not farther away from a surface region of the in-process 3D model, and discarding the transformed point if the transformed point is farther away from a surface region of the in-process 3D model.

In some embodiments, the image processing module determines whether tracking of the object in the scene is lost and executes an object recognition process to reestablish tracking of the object in the scene. In some embodiments, the object recognition process uses a reference model to reestablish tracking of the object in the scene. In some embodiments, the object in the scene is moved and/or rotated by hand. In some embodiments, the hand is visible in one or more of the plurality of images. In some embodiments, the one or more outlier points correspond to points associated with the hand in the 3D point cloud.

In some embodiments, the determined boundary comprises a boundary box generated by the image processing module. In some embodiments, the image processing module generates the boundary box by traversing a tracing ray from a location of the sensor through each point of the object in the scene. In some embodiments, updating the determined boundary comprises intersecting a boundary box for each scan together to form the updated boundary.

In some embodiments, the steps are performed in real time as the objects are moved and/or rotated in the scene. In some embodiments, the plurality of images comprises different angles and/or perspectives of the objects in the scene. In some embodiments, the sensor is moved and/or rotated in relation to the objects in the scene as the plurality of images is captured. In some embodiments, for the first filtered 3D point cloud generated from the scans of the images, the in-process 3D model is a predetermined reference model. In some embodiments, for each subsequent filtered 3D point cloud generated from the scans of the images, the in-process 3D model is the 3D model updated using the previous filtered 3D point cloud.

The invention, in another aspect, features a computerized method for recognizing a physical object in a scene. An image processing module of a computing device receives a plurality of images captured by a sensor coupled to the computing device, each image depicting a scene containing one or more physical objects. For each image, the image processing module:
(a) generates a scan of the image comprising a 3D point cloud corresponding to the scene and objects;
(b) determines a location of at least one target object in the scene by comparing the scan to an initial 3D reference model and extracts a 3D point cloud of the target object from the scan;
(c) resizes and reshapes the initial 3D reference model to correspond to dimensions of the extracted 3D point cloud to generate an updated 3D reference model; and
(d) determines whether the updated 3D reference model matches the target object.

If the updated 3D reference model does not match the target object, the image processing module performs steps (b)-(d) using the updated 3D reference model as the initial 3D reference model.

The invention, in another aspect, features a system for recognizing a physical object in a scene. The system includes a computing device executing an image processing module configured to receive a plurality of images captured by a sensor coupled to the computing device, each image depicting a scene containing one or more physical objects. For each image, the image processing module is configured to:
(a) generate a scan of the image comprising a 3D point cloud corresponding to the scene and objects;
(b) determine a location of at least one target object in the scene by comparing the scan to an initial 3D reference model and extract a 3D point cloud of the target object from the scan;
(c) resize and reshape the initial 3D reference model to correspond to dimensions of the extracted 3D point cloud to generate an updated 3D reference model; and
(d) determine whether the updated 3D reference model matches the target object.

If the updated 3D reference model does not match the target object, the image processing module is configured to perform steps (b)-(d) using the updated 3D reference model as the initial 3D reference model.

The invention, in another aspect, features a computer program product, tangibly embodied in a non-transitory computer readable storage device, for recognizing a physical object in a scene. The computer program product includes instructions operable to cause a computing device executing an image processing module to receive a plurality of images captured by a sensor coupled to the computing device, each image depicting a scene containing one or more physical objects. For each image, the computer program product includes instructions operable to cause the image processing module to:
(a) generate a scan of the image comprising a 3D point cloud corresponding to the scene and objects;
(b) determine a location of at least one target object in the scene by comparing the scan to an initial 3D reference model and extract a 3D point cloud of the target object from the scan;
(c) resize and reshape the initial 3D reference model to correspond to dimensions of the extracted 3D point cloud to generate an updated 3D reference model; and
(d) determine whether the updated 3D reference model matches the target object;

If the updated 3D reference model does not match the target object, perform steps (b)-(d) using the updated 3D reference model as the initial 3D reference model.

Any of the above aspects can include one or more of the following features. In some embodiments, the initial 3D reference model is determined by comparing a plurality of 3D reference models to the scan and selecting one of the 3D reference models that most closely matches the target object in the scan. In some embodiments, determining whether the updated 3D reference model matches the target object comprises determining whether an amount of deformation of the updated 3D reference model is within a predetermined tolerance. In some embodiments, the initial 3D reference model is determined by using a first scan as the initial model.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for generating a three-dimensional (3D) model of an object represented in a scene.

FIG. 2 is a flow diagram of a method for generating a three-dimensional (3D) model of an object represented in a scene.

FIG. 3 is a diagram of a workflow method for generating a three-dimensional (3D) model of an object represented in a scene.

FIG. 4A depicts an exemplary image of an object in a scene.

FIG. 4B depicts a raw scan of the object in the scene.

FIG. 4C depicts the scan of the object after flat surface removal is performed.

FIG. 5A is an image of the object of FIG. 4A as it is being rotated by hand.

FIG. 5B is a raw scan of the object of FIG. 5A.

FIG. 5C is a boundary box generated for the scan of FIG. 5B.

FIG. 6 depicts how a tracing ray traverses source points to generate the boundary box.

FIG. 7 depicts how the overall object boundary is updated using each individual object boundary detected from each scan of the object.

FIG. 8 is a cropped point cloud of the raw scan of FIG. 5B using the boundary box of FIG. 5C to remove the outliers (e.g., hand noises).

FIG. 9 is a detailed workflow diagram of a 3D model and boundary box update function.

FIG. 10A is an already finished surface of the object.

FIG. 10B is a raw source scan which includes the object and noise.

FIG. 10C is the denoised surface of the object.

FIG. 11 is the final 3D model of the object.

FIG. 12 is a diagram of a system and workflow method for standard 3D object detection and recognition.

FIG. 13A is a diagram of a system and workflow method for dynamic 3D object detection and recognition with implementation of a feedback loop without shape-based registration.

FIG. 13B is a diagram of a system and workflow method for dynamic 3D object detection and recognition with implementation of a feedback loop with shape-based registration.

FIG. 14 is a flow diagram for adaptive object recognition with implementation of a feedback loop.

### DETAILED DESCRIPTION

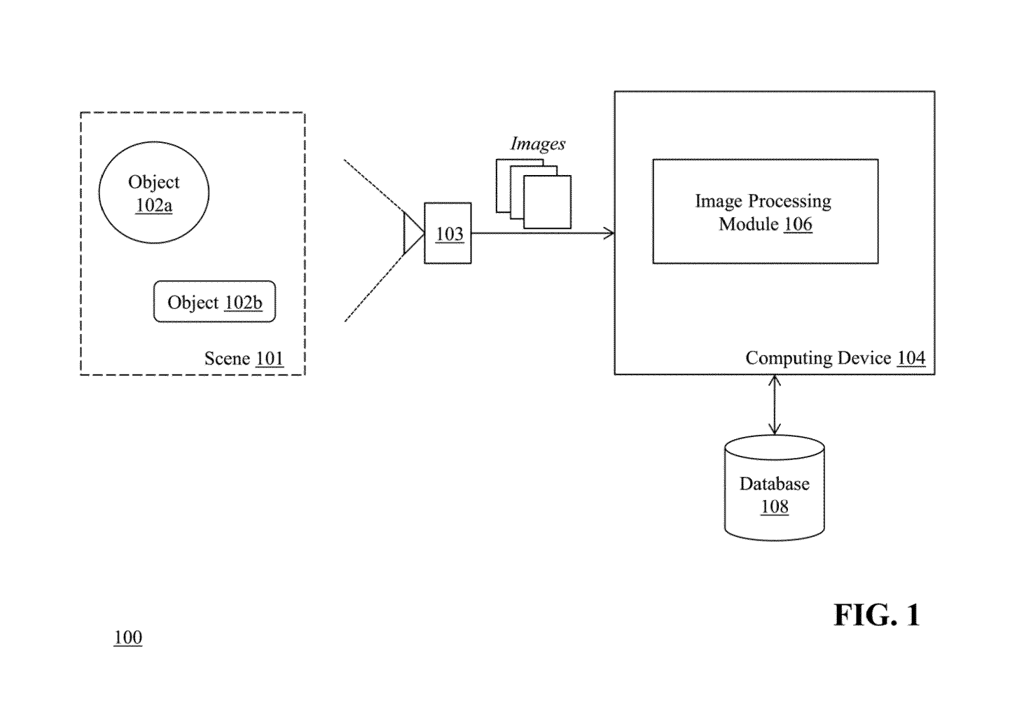

FIG. 1 is a block diagram of a system 100 for generating a three-dimensional (3D) model of an object represented in a scene. The system includes a sensor 103 coupled to a computing device 104. The computing device 104 includes an image processing module 106. In some embodiments, the computing device can also be coupled to a data storage module 108, e.g., used for storing certain 3D models such as reference models.

The sensor 103 is positioned to capture images of a scene 101 which includes one or more physical objects (e.g., objects 102a-102b). Exemplary sensors that can be used in the system 100 include, but are not limited to, 3D scanners, digital cameras, and other types of devices that are capable of capturing depth information of the pixels along with the images of a real-world object and/or scene to collect data on its position, location, and appearance. In some embodiments, the sensor 103 is embedded into the computing device 104, such as a camera in a smartphone, for example.

The computing device 104 receives images (also called scans) of the scene 101 from the sensor 103 and processes the images to generate 3D models of objects (e.g., objects 102a-102b) represented in the scene 101. The computing device 104 can take on many forms, including both mobile and non-mobile forms. Exemplary computing devices include, but are not limited to, a laptop computer, a desktop computer, a tablet computer, a smart phone, augmented reality (AR)/virtual reality (VR) devices (e.g., glasses, headset apparatuses, and so forth), an internet appliance, or the like. It should be appreciated that other computing devices (e.g., an embedded system) can be used without departing from the scope of the invention. The mobile computing device 102 includes network-interface components to connect to a communications network. In some embodiments, the network-interface components include components to connect to a wireless network, such as a Wi-Fi or cellular network, in order to access a wider network, such as the Internet.

The computing device 104 includes an image processing module 106 configured to receive images captured by the sensor 103 and analyze the images in a variety of ways, including detecting the position and location of objects represented in the images and generating 3D models of objects in the images. The image processing module 106 is a hardware and/or software module that resides on the computing device 104 to perform functions associated with analyzing images capture by the scanner, including the generation of 3D models based upon objects in the images. In some embodiments, the functionality of the image processing module 106 is distributed among a plurality of computing devices. In some embodiments, the image processing module 106 operates in conjunction with other modules that are either also located on the computing device 104 or on other computing devices coupled to the computing device 104. An exemplary image processing module is the Starry Night plug-in for the Unity 3D engine or other similar libraries, available from VanGogh Imaging, Inc. of McLean, Va. It should be appreciated that any number of computing devices, arranged in a variety of architectures, resources, and configurations (e.g., cluster computing, virtual computing, cloud computing) can be used without departing from the scope of the invention.

The data storage module 108 is coupled to the computing device 104, and operates to store data used by the image processing module 106 during its image analysis functions. The data storage module 108 can be integrated with the server computing device 104 or be located on a separate computing device.

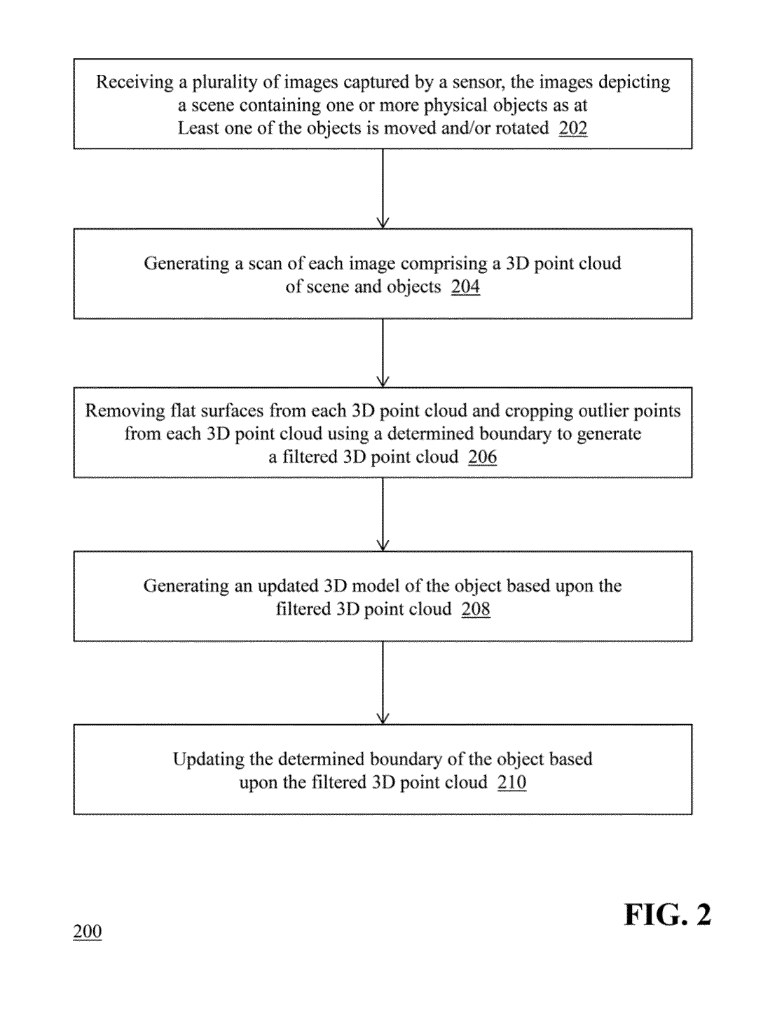

FIG. 2 is a flow diagram of a method 200 for generating a three-dimensional (3D) model of an object represented in a scene, using the system 100 of FIG. 1. The image processing module 106 of the computing device 104 receives (202) a plurality of images captured by the sensor 103, where the images depict a scene 101 containing one or more physical objects (e.g., objects 102a-102b) as at least one of the physical objects is moved and/or rotated. The image processing module 106 generates (204) a scan of each image comprising a 3D point cloud corresponding to the scene and objects. The image processing module 106 removes (206) flat surfaces from each 3D point cloud and crops (206) outlier points with a determined boundary of the object from each 3D point cloud without the flat surfaces to generate a filtered 3D point cloud of the object.

The image processing module 106 generates (208) an updated 3D model of the object based upon the filtered 3D point cloud and updates (210) the determined boundary of the object based upon the filtered 3D point cloud. Greater detail on each of the above-referenced steps is provided below.

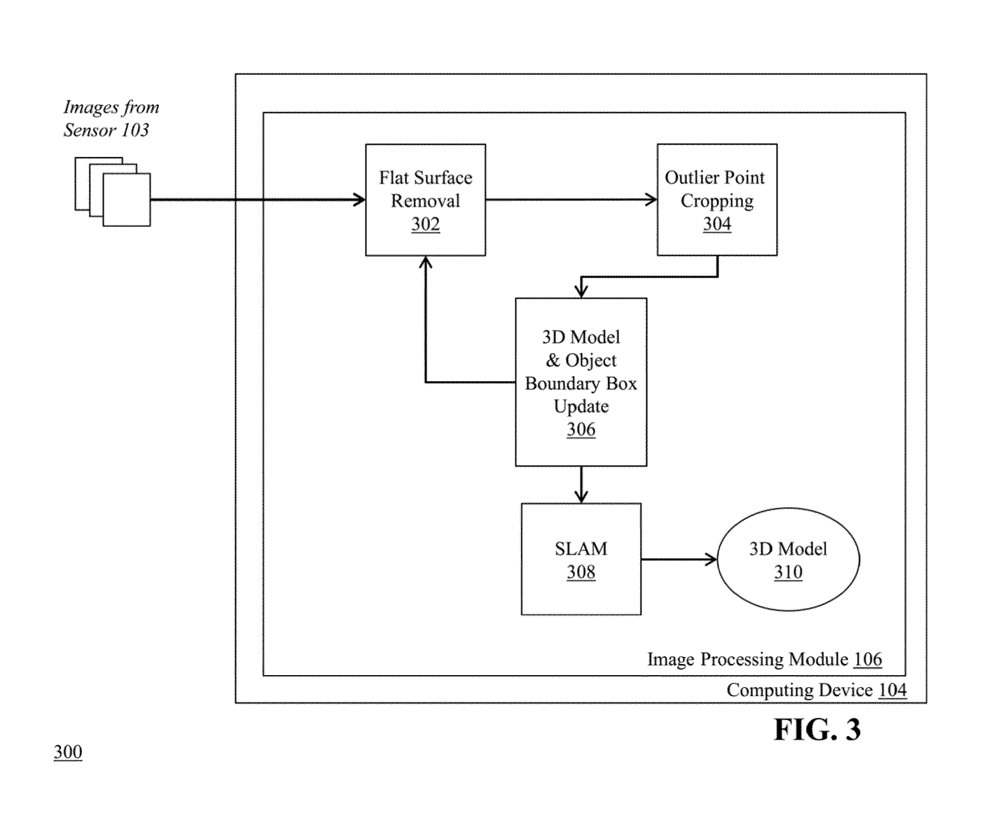

FIG. 3 is a diagram of a workflow method 300 for generating a three-dimensional (3D) model of an object represented in a scene, according to the method 200 of FIG. 2 and using the system 100 of FIG. 1. As shown in FIG. 3, the sensor 103 captures a plurality of images of a scene 101 containing one or more physical objects (e.g., objects 102a-102b) as at least one of the physical objects is moved and/or rotated and transmits the captured images (or scans) to the image processing module 106 of computing device 104. Generally, the methods and systems described herein utilize a 3D sensor (such as a 3D scanner) that provides individual images or scans of the scene 101 at multiple frames per second. The workflow method 300 includes four functions to be performed by the image processing module 106 in processing images received from the sensor 103: a flat surface removal function 302, a outlier point cropping function 304, a 3D model and object boundary box update function 306, and a Simultaneous Localization and Mapping (SLAM) function 308—to generate a 3D model 310 of the object.

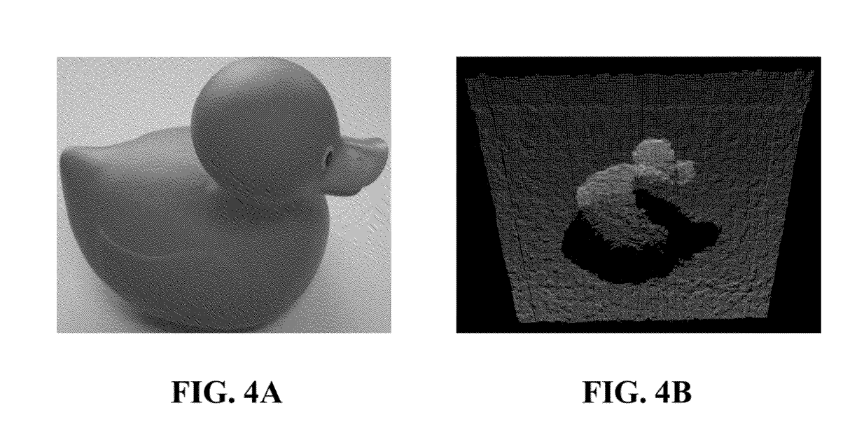

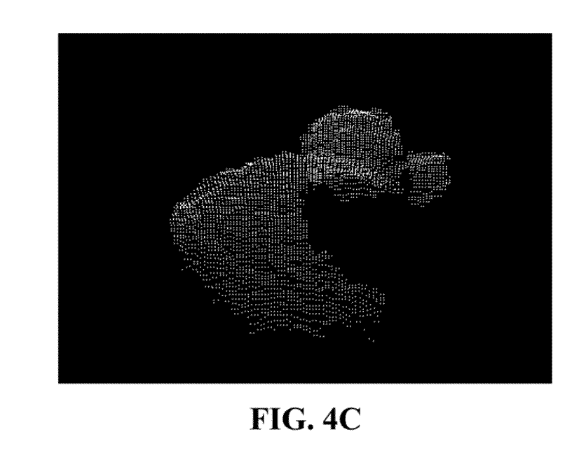

Upon receiving the raw scans from the sensor 103, the image processing module 106 performs the flat surface removal function 302 to remove planes (i.e., flat surfaces) from the scan of the object(s) 102a, 102b in the scene 101. FIG. 4A depicts an exemplary object in a scene (e.g., a rubber duck) and FIG. 4B depicts a raw scan of the object as received by the image processing module from the sensor 103. As shown in FIG. 4B, the scan includes a flat surface surrounding the object scan (e.g., a platform or table upon which the object is located).

FIG. 4C depicts the scan of the object after the flat surface removal function 302 is performed by the image processing module 106. As shown in FIG. 4C, the object scan still appears in the scan but the flat plane from FIG. 4B has been removed from the scan. One such method for removing flat surfaces includes randomly sampling a set of 3-points (e.g., each 3-points contains three points which can produce a plane) in the scene, determine a plane based on each 3-points, and check the distance between every point and the plane. If the point is very close to the plane, one can determine that this point likely resides on the plane. If a large number of points are on the same plane, then those points are determined to be on a flat surface. The number of the points to sample and the criteria in which to determine the flat surface depends on the size of the scene and the size of the flat surface that is visible to the camera.

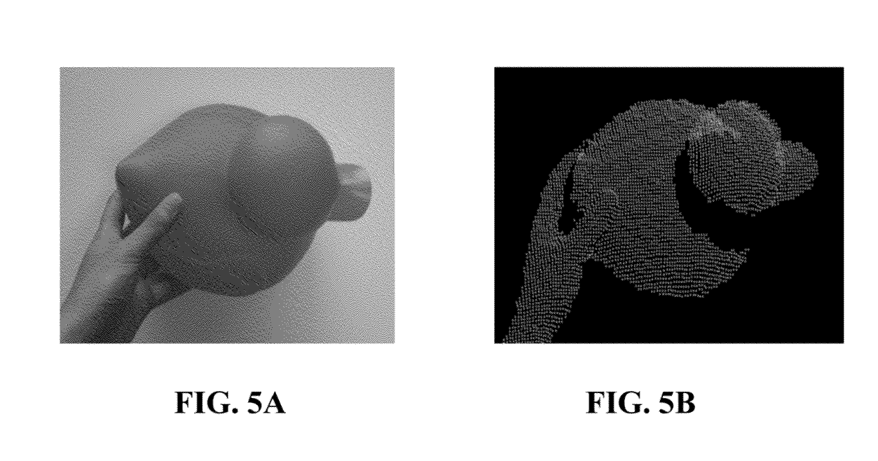

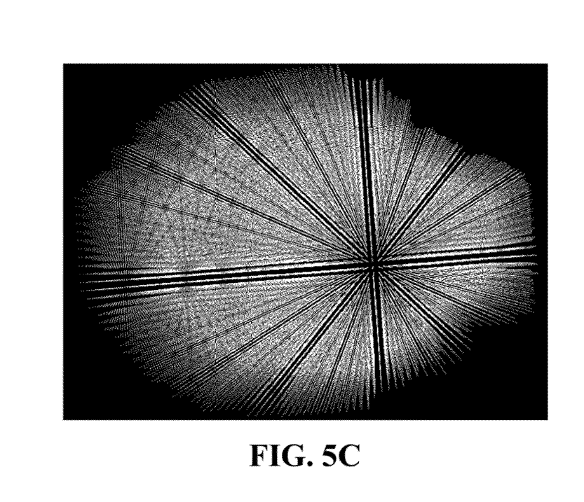

Once the image processing module 106 removes the flat surface(s) from the source scan, the image processing module 106 performs the outlier point cropping function 304 using a boundary box of the object that is generated by the image processing module 106. For example, if the object is being rotated by hand, the operator's hand will likely appear in the scans of the object received from the sensor 103. Because the hand is not part of the object for which the 3D model is generated, the points in the scan that correspond to the hand are considered outliers to be cropped out of the scan by the image processing module 106. FIG. 5A depicts the object of FIG. 4A (i.e., the rubber duck) after being rotated in relation to the sensor 103—now the sensor captures the duck from a top-down perspective instead of the plan view perspective of FIG. 4A. Also, as shown in FIG. 5A, the operator's hand is visible and holding the object in order to rotate the object in the scene. FIG. 5B depicts a raw scan of the object of FIG. 5A—again here, the operator's hand is visible in the left side of the scan.

In order to remove the outlier points (i.e., the hand points) from the scan, the image processing module 106 generates a boundary box of the object and then utilizes the object boundary to remove the outlier points. To generate the boundary box, the image processing module 106 traverses a tracing ray from the sensor 103 position through every point of the object. FIG. 5C depicts a boundary box generated by the image processing module 106 for the scan shown in FIG. 5B. It should be noted that the boundary box is not a ‘box’ per se—but a three-dimension shape very close around the object. The boundary box is registered to the object pose and therefore can be used to crop out any noises that are not a part of the object. The boundary box is thus refined every time the sensor sees the partial object, such that the boundary box continues to intersect the previous boundary box and get smaller and smaller until the boundary box is nearly closed to the shape of the object itself. This technique is successful because the object is the only constant in the scene while the rest of the scene (including the hand) appears and disappears as the viewing angle changes relative to the object.

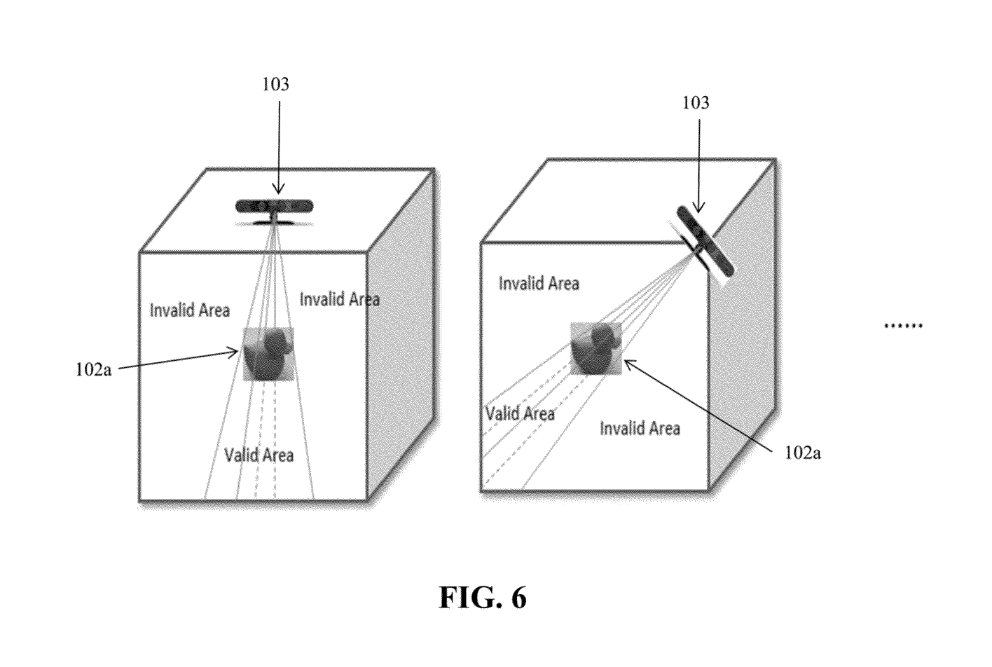

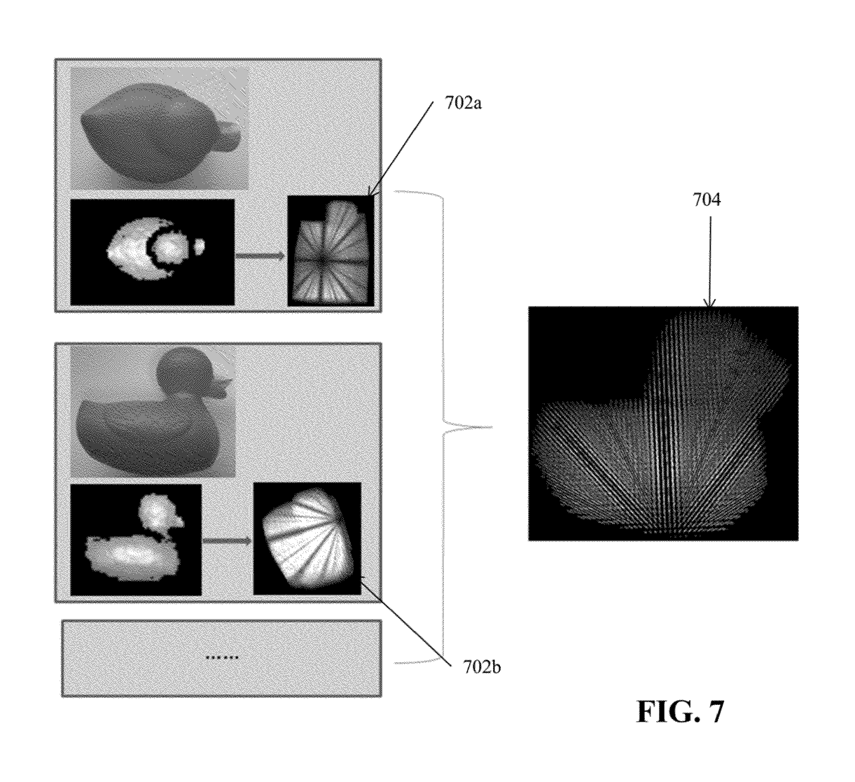

FIG. 6 depicts how the tracing ray traverses the source points to generate the object boundary box. As shown in FIG. 6, the sensor 103 captures a scan of the object 102a and detects the valid area of the object in the scan to generate the object boundary. As further scans of the object are captured (e.g., from different angles and/or perspectives of the object) and analyzed, the image processing module 106 intersects the object boundary from each source scan together to generate an overall object boundary. FIG. 7 depicts how the overall object boundary is updated using each individual object boundary detected from each scan of the object (e.g., at the various angles and perspectives as the object is rotated in the scene). As shown in FIG. 7, a scan of the object is taken from (i) a top-down perspective, and (ii) a side perspective. As can be appreciated, the sensor can capture scans from additional angles/perspectives (not shown). For each scan, the image processing module 106 removes flat surfaces and generates an object boundary 702a, 702b. The object boundaries 702a, 702b are then merged by the image processing module 106 to result in an overall 3D object boundary box 704. This process continues as each new scan is received by the image processing module 106.

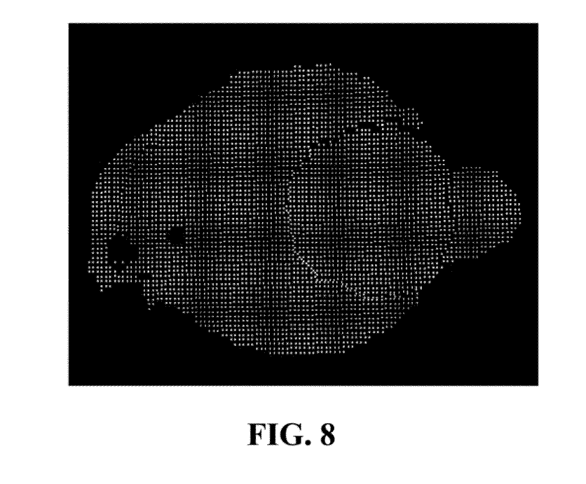

Turning back to FIG. 3, once the image processing module 106 has generated the object boundary box, the image processing module 106 crops the outlier points (e.g., the hand points) from the object scan to result in a cropped point cloud of the object with the outlier points removed. FIG. 8 depicts a cropped point cloud of the raw scan of FIG. 5B using the boundary box of FIG. 5C that was generated by the image processing module 106. As shown in FIG. 8, the object scan of the rubber duck no longer contains the points corresponding to the operator's hand and instead only contains points associated with the object.

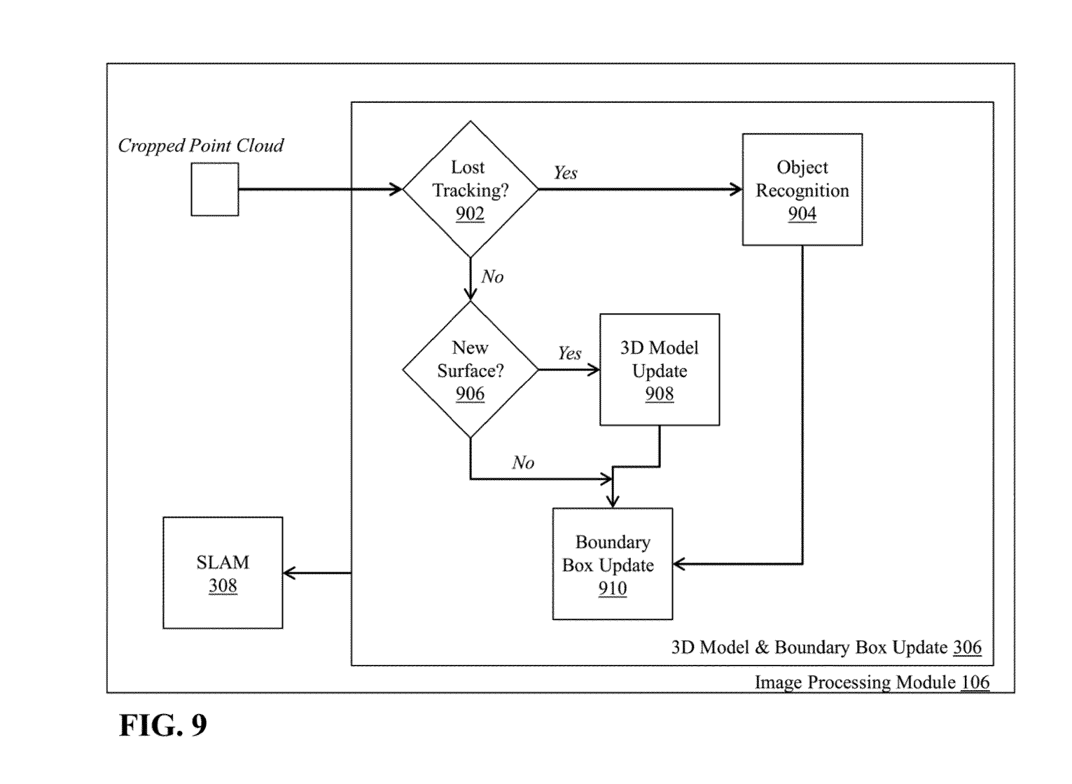

Returning to FIG. 3, the image processing module 106 performs the 3D model and boundary box update function 306 using the cropped point cloud. FIG. 9 is a detailed workflow diagram of the 3D model and boundary box update function 306.

As shown in FIG. 9, the cropped point cloud generated by the image processing module 106 for each of the object scans captured by the sensor 103 is analyzed as part of the 3D model and boundary box update function 306. In some cases, as the object is being moved and/or rotated by the operator, the image processing module 106 may lose tracking of the object in the scene. The image processing module determines (902) if tracking of the object as provided by SLAM is lost. If so, the image processing module 106 performs an object recognition function 904 to find the global tracking of the object. A detailed description of the exemplary object recognition function 904 will be provided below. During this step, the reference model used in the object recognition process is dynamically created using the Global Model generated from the D-SLAM. Also, if the reference model is fully generated, then the SLAM can be turned off and the fully-generated reference model can be used by the object recognition process to provide both the local and global tracking information to be used to fine-tune the quality of the 3D model using more refined 3D scanning techniques (such as higher resolution scanners).

Continuing with FIG. 9, once the image processing module 106 regains the pose of the object, the module 106 performs an update 910 of the overall boundary box position for the object and processes the next scan received from the sensor 103 (e.g., flat surface removal, outlier point cropping, etc.)

If the image processing module 106 has not lost tracking of the object in the scene, the image processing module 106 determines (906) if parts of the cropped point cloud corresponds to a new surface of the object previously unseen from the sensor (i.e., a pose, angle, and/or perspective of the object that has not been captured yet). If the cropped point cloud does not correspond to a new surface, the image processing module 106 performs the boundary box update function 910 to update the overall boundary box of the object based upon the current scan. If the cropped point cloud does correspond to a new surface, the image processing module 106 performs an update 908 of the 3D model of the object and then the boundary box is updated based upon the updated 3D model.

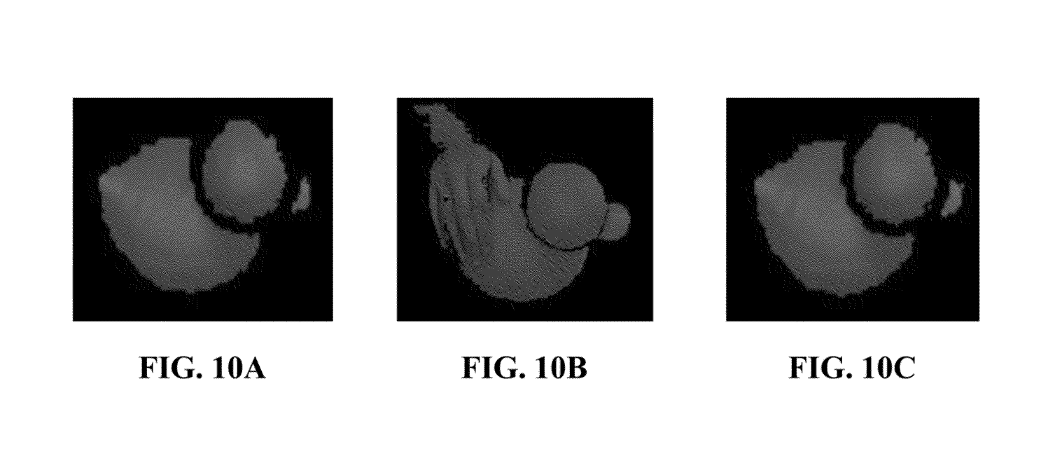

To update the 3D model, the image processing module 106 adds the filtered source scan (i.e., the point cloud with the flat surface(s) removed and outlier points cropped) into the 3D model (also called denoised reconstruction). As an example, during the scanning step the same surface of the object is typically scanned multiple times. When the filtered source scan is fused into the 3D model, each point is transformed by its rotation matrix and translation vector. If the transformed point in the filtered source scan is farther away from an already observable surface region of the object, the transformed point is not updated into the 3D model. An example of this processing is shown in FIGS. 10A-10C. FIG. 10A shows an already finished surface of the 3D model of the object. FIG. 10B is the raw source scan which includes the object and noise (i.e., hand points) and FIG. 10C is the ‘denoised’ surface (i.e., the surface of the object without noise). In this example, the hand is above the duck surface—which has been already observed in previous scans—and the hand points are considered as the noise and thus not updated into the 3D model. This information can be obtained by looking at both the surface normal of new point as well as whether the new point is closer to the sensor than the existing surface. If the new point is further away from the existing surface, it can be determined that the new point is ‘noise’ and is not updated to the existing surface. If, however, the new point is closer to the surface, it can then be used to update to the existing surface. This denoised reconstruction approach optimally guarantees the surface reconstruction with a high quality from noisy scans. Turning back to FIG. 9, once the image processing module 106 updates the 3D model, the module 106 performs the boundary box update function 910 to update the overall boundary box of the object based upon the current scan.

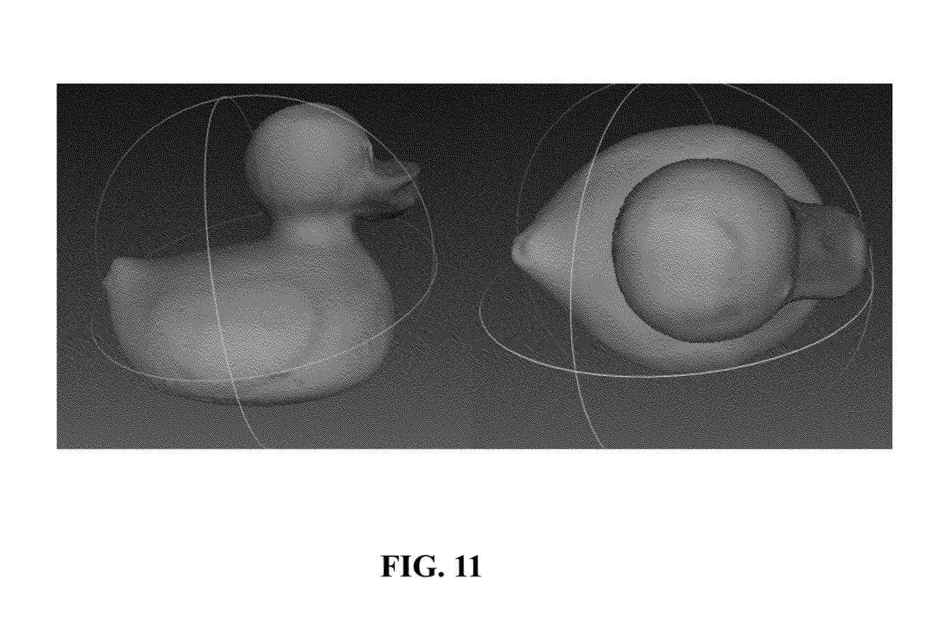

After each of the scans captured by the sensor 103 has been processed by the image processing module 106, a final 3D model is generated by the system 100. FIG. 11 shows the final 3D model using the object recognition and reconstruction techniques described herein. As shown in FIG. 11, the 3D model depicts the object from the scene (e.g., the rubber duck), but notably does not depict the outlier points (e.g., the user's hand) that were contained in scans received from the 3D sensor 103.

Adaptive Object Recognition

The following section describes the process of Adaptive Object Recognition as performed by the system 100 of FIG. 1. The Adaptive Object Recognition process described herein is an important part of the overall 3D modeling process.

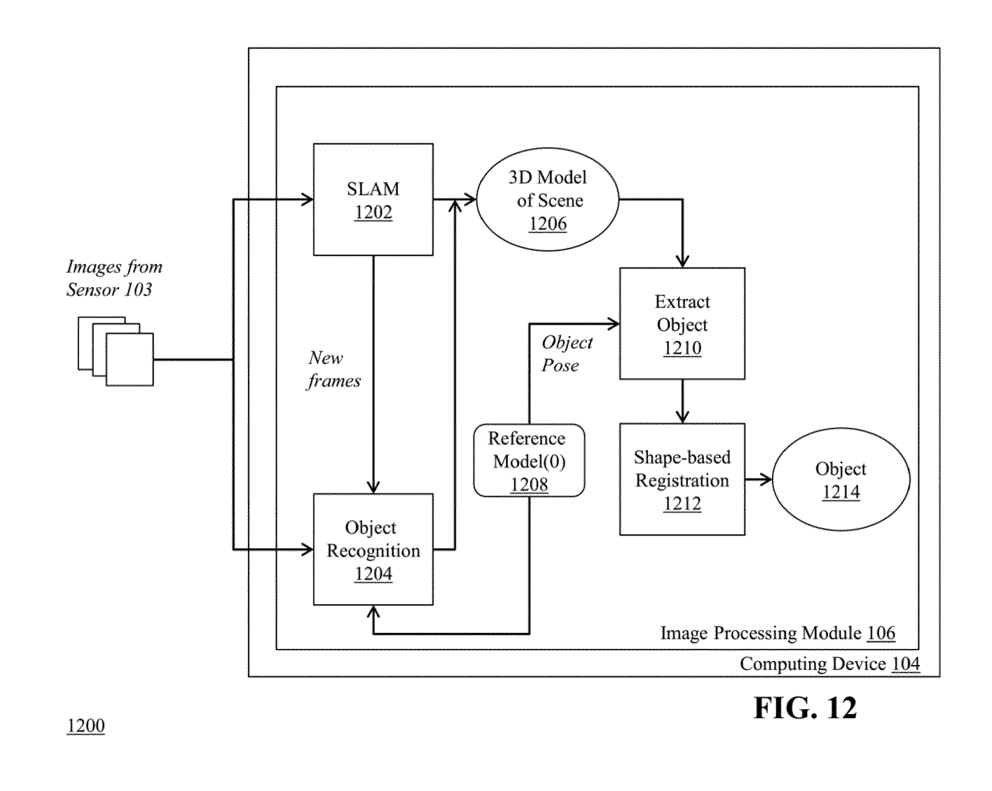

FIG. 12 is a diagram of a system and workflow method 1200 for 3D object detection and recognition, using the system 100 of FIG. 1. The workflow method 1200 includes four functions to be performed by the image processing module 106 for processing images received from the sensor 103: a Simultaneous Localization and Mapping (SLAM) function 1202, an object recognition function 1204, an extract object function 1210, and a shape-based registration function 1212.

There are two initial conditions. Condition One is when it is known beforehand what the object shape generally looks like. In this case, the system can use the initial reference model of shape that is very similar to the object being scanned (i.e. if the object is a dog, use a generic dog model as the reference model(0)). Further, the system can use a shape-based registration technique to generate a fully-formed 3D model of the latest best fit object from the scene. Subsequent reference model(i) is then used to find the object in the scene. Condition Two is when we do not know what the object shape looks like initially. In this case, we can use the very first scan as the reference model(0). In the second case, the system cannot use the shape-based registration since it does not have the generic model in order to form a fully-formed 3D model. Either way, the system can still track and update the 3D model of the object.

As set forth previously, the methods and systems described herein utilize a 3D sensor 103 (such as a 3D scanner) that provides individual images or scans of the scene 101 at multiple frames per second. The SLAM function 1202 constructs the scene in 3D by stitching together multiple scans in real time. The Object Recognition function 1204 is also performed in real time by examining the captured image of the scene and looking for an object in the scene based on a 3D reference model. Once the system 100 has recognized the object's location and exact pose (i.e., orientation), points associated with the object are then extracted from the scene. Then, the extract object function 1210 extracts the points of just the object from the scene and converts the points to the 3D model. If there is a closed formed generic model, the system can then use the shape-based registration function 1212 to convert these points into a fully-formed, watertight 3D model. In some embodiments, this process is conducted in real-time.

It should also be appreciated that while the functions 1202, 1204, 1210, and 1212 are designed to be performed together, e.g., in a workflow as shown in FIG. 12, certain functions can be performed independently of the others. As an example, the object recognition function 1204 can be performed as a standalone function. Further, there are several parameters such as scene size, scan resolution, and others that allow an application developer to customize the image processing module 106 to maximize performance and reduce overall system cost. Some functions—such as shape-based registration (e.g., 3D reconstruction) function 1210—can only work in conjunction with the object recognition function 1204 because the shape-based registration function 1212 uses information relating to points in the scene 101 that are a part of the object (e.g., object 102a) the system 100 is reconstructing. A more detailed description of each function 1202, 1204, 1210, and 1212 is provided in U.S. patent application Ser. No. 14/324,891, which is incorporated herein by reference.

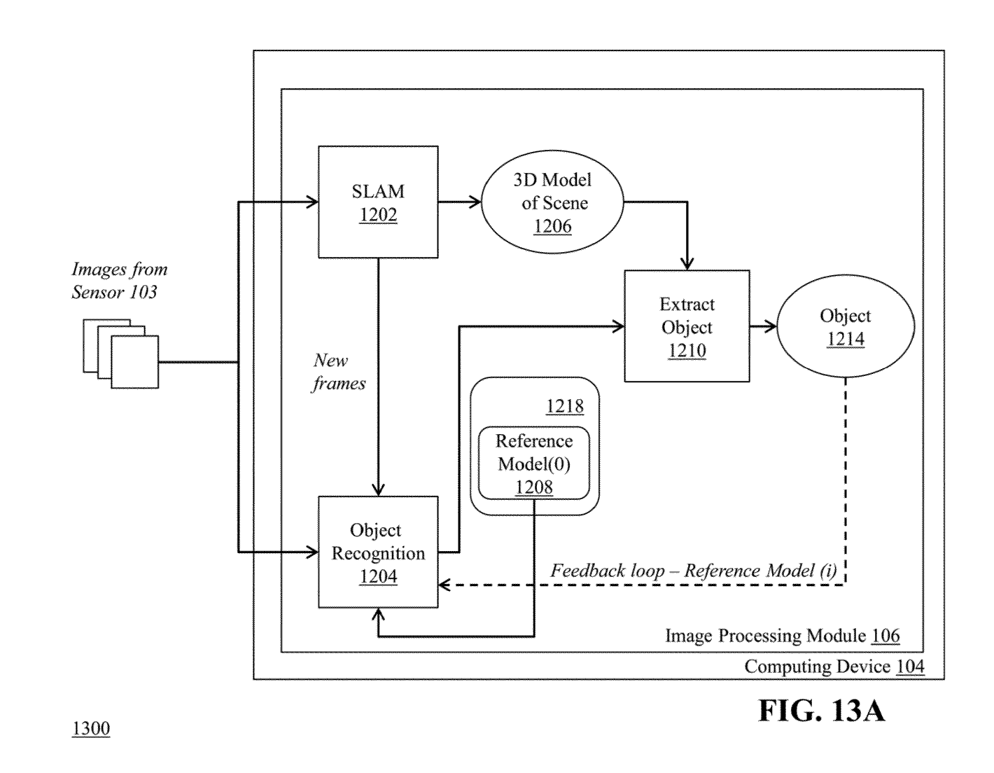

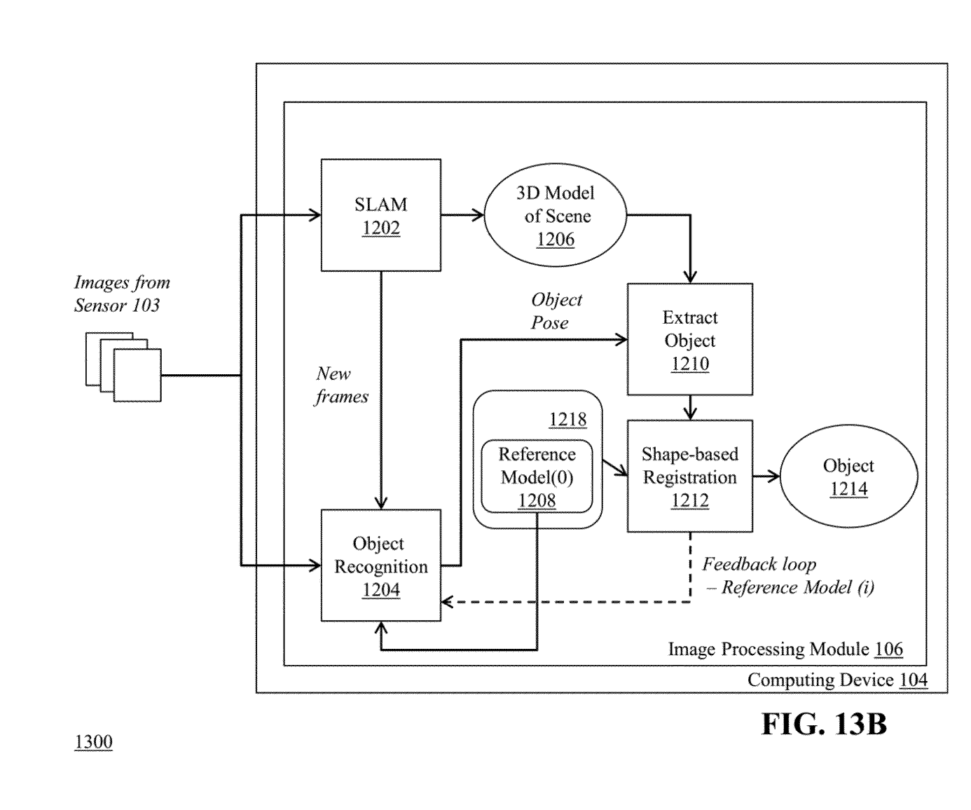

FIG. 13A is a diagram of a system and workflow method 1300 for 3D object detection and recognition with implementation of a feedback loop for unknown objects (Condition Two as described above), using the system 100 of FIG. 1. In this case, reference model(0) 1208 is the first scan with the flat surface removed and therefore contains just the partial scan of the object.

As shown in FIG. 13A, a feedback loop is implemented after the extract object function 1210 sends back the object points from the scene as a new reference model to the object recognition function 1204. Hence, the object recognition function 1204 is constantly looking for the latest and most updated 3D model of the object. Further, in some embodiments, all function blocks 1202, 1204, and 1210 depicted in FIG. 13 run in real-time. In some embodiments, some of the function blocks 1202, 1204, and 1210 may run in a post-processing phase, in the event there are processing limitations of the hardware and/or the application.

FIG. 13B is a diagram of a system and workflow method 1300 for 3D object detection and recognition with implementation of a feedback loop for known objects (Condition One as described above), using the system 100 of FIG. 1. In this case, reference model(0) 1208 is the closed form 3D model of a shape that is similar to the object to be recognized and extracted from the scene.

As shown in FIG. 13B, a feedback loop is implemented after the extract object function 1210 sends the points to the shape-based registration to form a modified closed-form 3D model based on the captured points. This new object is sent back as new reference model(i) to the object recognition function 1204. Hence, the object recognition function 1204 is constantly looking for the latest and most updated 3D model of the object in the scene. Further, in some embodiments, all function blocks 1202, 1204, 1210, and 1212 depicted in FIG. 13B run in real-time. In some embodiments, some of the function blocks 1202, 1204, 1210, and 1212 may run in a post-processing phase, in the event there are processing limitations of the hardware and/or the application.

As shown in FIG. 13B, the object recognition function 1204 initially uses the original reference model (i.e., reference model(0) 1208) to find the initial position of the object in the scene. The extract object function 1210 then extracts the points of the object from the scene associated with the object (i.e., 3D Model of Scene 1206). The reference model is then resized and reshaped to match the object's size and shape in the scene, using the shape-based registration block 1212. In a case where the sizes and shapes of the 3D model(s) are significantly different from the reference model, multiple reference models of various shapes and sizes can be stored in a Model Library 1218 and are used to find the ‘initial’ reference model(0) 1208. For example, in case of a dog, models of, e.g., ten different sizes/breeds of dog can be stored in the Model Library 1218. Details of an object recognition algorithm for multiple objects is described in U.S. patent application Ser. No. 14/324,891, which is incorporated herein by reference

Once the initial reference model 1208 is resized and reshaped, the resized and reshaped reference model is then sent to the object recognition function 1204 as reference model(1). After the next scan/frame, another new reference model is created by the shape-based registration function 1212 and is now reference model(2), and so forth. At some point after enough frames from different angles have been processed, the latest reference model(N) is exactly the same as (or within an acceptable tolerance of) the object in the scene.

In some embodiments, the number of iterations of the feedback loop required to determine a match between the reference model and the object can vary and depends on a number of different factors. For example, the object to be located in the scene can have several characteristics that affects the number of iterations such as: the shape of the object, how symmetric the object is, whether there are hidden views of the object (e.g., underneath), whether there are gaps or holes in the object, the number of angles of the object that are captured (e.g., is a 360-degree view required?), whether the object is moving, and the like. Also, the specific application for which the object recognition is being performed can affect the number of iterations—some applications require a greater degree of accuracy and detail and thus may require a greater number of iterations.

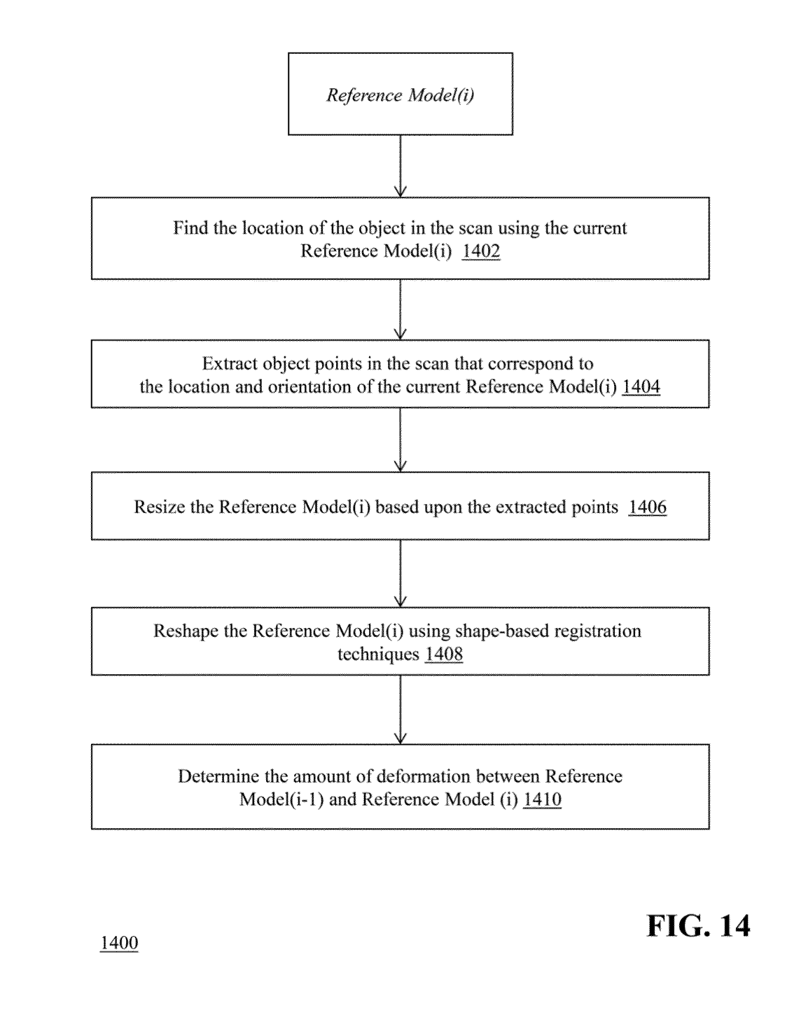

FIG. 14 is a flow diagram 1400 for adaptive object recognition with implementation of a feedback loop, using the workflow method 1300 of FIG. 13A-13B and the system 100 of FIG. 1. FIG. 14 shows how the iterative processing provided by implementation of the feedback loop refines the reference model until the system 100 is satisfied that the amount of deformation between the previous model and the current model from multiple viewing angles is quite small—which means that the reference model essentially matches the object in the scene. For example, in some applications, the amount of deformation allowed (expressed as a percentage) to qualify as a ‘match’ is 5% (meaning that there is 95% matching). However, in other applications, a greater accuracy is desired so the amount of deformation allowed to qualify as a ‘match’ is only 1%.

The image processing module 106 finds (1402) the location of the object in the scan using the current reference model(i). For example, at the beginning of the iterative process, the current reference model is reference model(0) and increments by one each time a new reference model is generated by the shape-based registration block 1210 (of FIG. 13).

The image processing module 106 extracts (1404) object points in the scan that correspond to the location and orientation of the current reference model(i). The image processing module 106 then resizes (1406) the reference Model(i) based upon the extracted points, and reshapes (1408) the reference model(i) using shape-based registration techniques.

Once the reference model(i) is resized and reshaped, the image processing module 106 determines (1410) the amount of deformation (as a percentage) between the previous model (i.e., reference model(i−1)) and the current model. If the amount of deformation exceeds a predetermined threshold (e.g., X %), then the image processing module 106 uses the resized and reshaped reference model(i) as a starting point (now reference model(i+1)) to find the location of the object in the scan, extract object points in the scan that correspond to the location and orientation of the reference model(i+1), resize and reshape the reference model(i+1), and determine the amount of deformation between reference model(i) and reference model(i+1).

If the amount of deformation between the previous reference model and the current reference model is less than a predetermined threshold, then the image processing module 106 concludes that the current reference model matches the object in the scene and can determine the location and orientation of the object in the scene.

In some embodiments, the methods and systems can integrate with multiple operating system platforms (e.g., those supported by the Unity 3D Game Engine available from Unity Technologies of San Francisco, Calif.), such as the Android mobile device operating system. Further, some embodiments of the methods and systems described herein are designed to take advantage of hardware acceleration techniques, such as using a field programmable gate array (FPGA), a graphics processing unit (GPU), and/or a digital signal processor (DSP).

As explained above, exemplary techniques provided by the methods and systems described herein include Simultaneous Localization and Mapping (SLAM) functions, which are used for 3D reconstruction, augmented reality, robot controls, and many other applications. Other exemplary techniques include object recognition capability for any type of 3D object. The SLAM and object recognition capabilities can be enhanced to include analysis tools for measurements and feature extraction. In some embodiments, the systems and methods described herein interface to any type of 3D sensor or stereo camera (e.g., Occipital Structured or Intel RealSense™ 3D Sensors).

Also, the methods, systems, and techniques described herein are applicable to a wide variety of useful commercial and/or technical applications. Such applications can include:
Augmented Reality—to capture and track real-world objects from a scene for representation in a virtual environment;
3D Printing—real-time dynamic three-dimensional (3D) model reconstruction with occlusion or moving objects as described herein can be used to create a 3D model easily by simply rotating the object by hand and/or via a manual device. The hand (or turntable), as well as other non-object points, are simply removed in the background while the surface of the object is constantly being updated with the most accurate points extracted from the scans. The methods and systems described herein can also be in conjunction with higher-resolution lasers or structured light scanners to track object scans in real-time to provide accurate tracking information for easy merging of higher-resolution scans.
Entertainment—For example, augmented or mixed reality applications can use real-time dynamic three-dimensional (3D) model reconstruction with occlusion or moving objects as described herein to dynamically create 3D models of objects or features, which can then be used to super-impose virtual models on top of real-world objects. The methods and systems described herein can also be used for classification and identification of objects and features. The 3D models can also be imported into video games.
Parts Inspection—real-time dynamic three-dimensional (3D) model reconstruction with occlusion or moving objects as described herein can be used to generate a 3D model which can then be compared to a reference CAD model to be analyzed for any defects or size differences.
E-commerce/Social Media—real-time dynamic three-dimensional (3D) model reconstruction with occlusion or moving objects as described herein can be used to easily model humans or other real-world objects which are then imported into e-commerce or social media applications or websites.
Other applications—any application that requires 3D modeling or reconstruction can benefit from this reliable method of extracting just the relevant object points and removing points resulting from occlusion in the scene and/or a moving object in the scene.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the technology may be embodied in other specific forms without departing from the spirit or essential characteristics thereof. The foregoing embodiments are therefore to be considered in all respects illustrative rather than limiting of the technology described herein.

What is claimed is:

1. A computerized method for generating a three-dimensional (3D) model of an object represented in a scene, the method comprising:
receiving, by an image processing module executing on a processor of a computing device, a plurality of images captured by a sensor coupled to the computing device, each image depicting a scene containing one or more physical objects, wherein at least one of the objects moves and/or rotates between capture of different images;
generating, by the image processing module, a scan of each image comprising a 3D point cloud corresponding to the scene and objects;
removing, by the image processing module, one or more flat surfaces from each 3D point cloud and cropping one or more outlier points from the 3D point cloud after the flat surfaces are removed using a determined boundary of the object to generate a filtered 3D point cloud of the object;
generating, by the image processing module, an updated 3D model of the object based upon the filtered 3D point cloud and an in-process 3D model; and
updating, by the image processing module, the determined boundary of the object based upon the filtered 3D point cloud.

2. The method of claim 1, wherein the step of generating an updated 3D model of the object comprises
transforming, by the image processing module, each point in the filtered 3D point cloud by a rotation matrix and translation vector corresponding to each point in the initial 3D model;
determining, by the image processing module, whether the transformed point is farther away from a surface region of the in-process 3D model;
merging, by the image processing module, the transformed point into the in-process 3D model to generate an updated 3D model, if the transformed point is not farther away from a surface region of the in-process 3D model; and
discarding, by the image processing module, the transformed point if the transformed point is farther away from a surface region of the in-process 3D model.

3. The method of claim 1, further comprising
determining, by the image processing module, whether tracking of the object in the scene is lost; and
executing, by the image processing module, an object recognition process to reestablish tracking of the object in the scene.

4. The method of claim 3, wherein the object recognition process uses a reference model to reestablish tracking of the object in the scene.

5. The method of claim 1, wherein the object in the scene is moved and/or rotated by hand.

6. The method of claim 5, wherein the hand is visible in one or more of the plurality of images.

7. The method of claim 6, wherein the one or more outlier points correspond to points associated with the hand in the 3D point cloud.

8. The method of claim 1, wherein the determined boundary comprises a boundary box generated by the image processing module.

9. The method of claim 8, wherein the image processing module generates the boundary box by traversing a tracing ray from a location of the sensor through each point of the object in the scene.

10. The method of claim 9, wherein the step of updating the determined boundary comprises intersecting, by the image processing module, a boundary box for each scan together to form the updated boundary.

11. The method of claim 1, wherein the steps are performed in real time as the objects are moved and/or rotated in the scene.

12. The method of claim 1, wherein the plurality of images comprises different angles and/or perspectives of the objects in the scene.

13. The method of claim 12, wherein the sensor is moved and/or rotated in relation to the objects in the scene as the plurality of images are captured.

14. The method of claim 1, wherein for the first filtered 3D point cloud generated from the scans of the images, the in-process 3D model is a predetermined reference model.

15. The method of claim 14, wherein for each subsequent filtered 3D point cloud generated from the scans of the images, the in-process 3D model is the 3D model updated using the previous filtered 3D point cloud.

16. A system for generating a three-dimensional (3D) model of an object represented in a scene, the system comprising
a sensor coupled to a computing device,
the computing device comprising a processor executing an image processing module configured to
receive a plurality of images captured by the sensor, each image depicting a scene containing one or more physical objects, wherein at least one of the objects moves and/or rotates between capture of different images;
generate a scan of each image comprising a 3D point cloud corresponding to the scene and objects;
remove one or more flat surfaces from each 3D point cloud and crop one or more outlier points from the 3D point cloud after the flat surfaces are removed using a determined boundary of the object to generate a filtered 3D point cloud of the object;
generate an updated 3D model of the object based upon the filtered 3D point cloud and an in-process 3D model; and
update the determined boundary of the object based upon the filtered 3D point cloud.

17. The system of claim 16, wherein when generating an updated 3D model of the object, the image processing module is configured to
transform each point in the filtered 3D point cloud by a rotation matrix and translation vector corresponding to each point in the initial 3D model;
determine whether the transformed point is farther away from a surface region of the in-process 3D model;
merge the transformed point into the in-process 3D model to generate an updated 3D model, if the transformed point is not farther away from a surface region of the in-process 3D model; and
discard the transformed point if the transformed point is farther away from a surface region of the in-process 3D model.

18. The system of claim 16, wherein the image processing module is further configured to
determine whether tracking of the object in the scene is lost; and
execute an object recognition process to reestablish tracking of the object in the scene.

19. The system of claim 18, wherein the object recognition process uses a reference model to reestablish tracking of the object in the scene.

20. The system of claim 16, wherein the object in the scene is moved and/or rotated by hand.

21. The system of claim 20, wherein the hand is visible in one or more of the plurality of images.

22. The system of claim 21, wherein the one or more outlier points correspond to points associated with the hand in the 3D point cloud.

23. The system of claim 16, wherein the determined boundary comprises a boundary box generated by the image processing module.

24. The system of claim 23, wherein the image processing module is configured to generate the boundary box by traversing a tracing ray from a location of the sensor through each point of the object in the scene.

25. The system of claim 24, wherein the step of updating the determined boundary comprises intersecting, by the image processing module, a boundary box for each scan together to form the updated boundary.

26. The system of claim 16, wherein the steps are performed in real time as the objects are moved and/or rotated in the scene.

27. The system of claim 16, wherein the plurality of images comprises different angles and/or perspectives of the objects in the scene.

28. The system of claim 27, wherein the sensor is moved and/or rotated in relation to the objects in the scene as the plurality of images are captured.

29. A computer program product, tangibly embodied in a non-transitory computer readable storage device, for generating a three-dimensional (3D) model of an object represented in a scene, the computer program product including instructions operable to cause an image processing module executing on a processor of a computing device to
receive a plurality of images captured by a sensor coupled to the computing device, each image depicting a scene containing one or more physical objects, wherein at least one of the objects moves and/or rotates between capture of different images;
generate a scan of each image comprising a 3D point cloud corresponding to the scene and objects;
remove one or more flat surfaces from each 3D point cloud and crop one or more outlier points from the 3D point cloud after the flat surfaces are removed using a determined boundary of the object to generate a filtered 3D point cloud of the object;
generate an updated 3D model of the object based upon the filtered 3D point cloud and an in-process 3D model; and
update the determined boundary of the object based upon the filtered 3D point cloud.

30. A computerized method for recognizing a physical object in a scene, the method comprising
receiving, by an image processing module executing on a processor of a computing device, a plurality of images captured by a sensor coupled to the computing device, each image depicting a scene containing one or more physical objects;
for each image:
(a) generating, by the image processing module, a scan of the image comprising a 3D point cloud corresponding to the scene and objects;
(b) determining, by the image processing module, a location of at least one target object in the scene by comparing the scan to an initial 3D reference model and extracting a 3D point cloud of the target object from the scan;
(c) resizing and reshaping, by the image processing module, the initial 3D reference model to correspond to dimensions of the extracted 3D point cloud to generate an updated 3D reference model; and
(d) determining, by the image processing module, whether the updated 3D reference model matches the target object;
if the updated 3D reference model does not match the target object, performing steps (b)-(d) using the updated 3D reference model as the initial 3D reference model.

31. The method of claim 30, wherein the initial 3D reference model is determined by comparing a plurality of 3D reference models to the scan and selecting one of the 3D reference models that most closely matches the target object in the scan.

32. The method of claim 30, wherein the step of determining whether the updated 3D reference model matches the target object comprises determining whether an amount of deformation of the updated 3D reference model is within a predetermined tolerance.

33. A system for recognizing a physical object in a scene, the system comprising an image processing module executing on a processor of a computing device, the module configured to
receive a plurality of images captured by a sensor coupled to the computing device, each image depicting a scene containing one or more physical objects;
for each image:
(a) generate a scan of the image comprising a 3D point cloud corresponding to the scene and objects;
(b) determine a location of at least one target object in the scene by comparing the scan to an initial 3D reference model and extract a 3D point cloud of the target object from the scan;
(c) resize and reshape the initial 3D reference model to correspond to dimensions of the extracted 3D point cloud to generate an updated 3D reference model; and
(d) determine whether the updated 3D reference model matches the target object;
if the updated 3D reference model does not match the target object, perform steps (b)-(d) using the updated 3D reference model as the initial 3D reference model.

34. The system of claim 33, wherein the initial 3D reference model is determined by comparing a plurality of 3D reference models to the scan and selecting one of the 3D reference models that most closely matches the target object in the scan.

35. The system of claim 33, wherein determining whether the updated 3D reference model matches the target object comprises determining whether an amount of deformation of the updated 3D reference model is within a predetermined tolerance.

36. A computer program product, tangibly embodied in a non-transitory computer readable storage device, for recognizing a physical object in a scene, the computer program product comprising instructions operable to cause an image processing module executing on a processor of a computing device to
receive a plurality of images captured by a sensor coupled to the computing device, each image depicting a scene containing one or more physical objects;
for each image:
(a) generate a scan of the image comprising a 3D point cloud corresponding to the scene and objects;
(b) determine a location of at least one target object in the scene by comparing the scan to an initial 3D reference model and extract a 3D point cloud of the target object from the scan;
(c) resize and reshape the initial 3D reference model to correspond to dimensions of the extracted 3D point cloud to generate an updated 3D reference model; and
(d) determine whether the updated 3D reference model matches the target object;
if the updated 3D reference model does not match the target object, perform steps (b)-(d) using the updated 3D reference model as the initial 3D reference model.
